(19) United States
(12) Patent Application Publication
(10) Pub. No.: US 2014/0189184 A1
(43) Pub. Date: Jul. 3, 2014

(54) CREATING DYNAMIC FIXED FUNCTIONALITY FOR A HARDWARE DEVICE SYSTEM

(71) Applicants: Nicholas Adams, Beaverton, OR (US); Robert Gough, Sherwood, OR (US); Gary Lee, Banqiao City (TW)

(72) Inventors: Nicholas Adams, Beaverton, OR (US); Robert Gough, Sherwood, OR (US); Gary Lee, Banqiao City (TW)

(21) Appl. No.: 13/730,613

(22) Filed: Dec. 28, 2012

(51) Int. Cl. G06F 13/24

(52) U.S. Cl. CPC G06F 13/24
USPC 710/266

(57) ABSTRACT

One particular example implementation of an apparatus that includes logic, the logic at least partially comprising hardware logic to: trigger a particular interrupt based, at least in part, on input/output (I/O) activity when a predetermined state is activated on a platform; generate a system control interrupt based, at least in part, on a source associated with the particular interrupt; and route the system control interrupt to a custom system control interrupt handler.

### TECHNICAL FIELD

Embodiments described herein generally relate to a fixed functionality for a hardware device system.

### BACKGROUND

As electronic devices become more complex and more ubiquitous in the everyday lives of users, more and more diverse requirements are placed upon them. For example, many electronic devices can operate in different modes, thus allowing users to operate these devices in many different circumstances. In addition, as capabilities of electronic devices become more extensive, many users may become reliant on the enhanced performance such capabilities provide. For example, many electronic devices can operate on battery power, thus allowing users to operate these devices in many different circumstances. As these aspects of electronic devices have evolved, there has become an increasing need for power optimization so that users may enjoy longer battery life. However, under many circumstances, power optimization may sacrifice performance. For example, often a specific component will have a desired performance, and then enter into a low power state during circumstances where the specific component is not needed. It would be advantageous if an electronic device could enter different power states as appropriate, where the entrance or exit from those power states could include (or produce) a desired function or action.

### BRIEF DESCRIPTION OF THE DRAWINGS

Embodiments are illustrated by way of example and not limitation in the figures of the accompanying drawings, in which like references indicate similar elements and in which:

FIG. 1 is a simplified schematic diagram illustrating an embodiment of an electronic device, in accordance with at least one example embodiment of the present disclosure;

FIG. 2 illustrates, for at least one embodiment, an example flow diagram in accordance with at least one example embodiment of the present disclosure;

FIGS. 3A and 3B illustrate, for at least one embodiment, an example flow diagram in accordance with at least one example embodiment of the present disclosure;

FIGS. 4A and 4B illustrate, for at least one embodiment, an example flow diagram in accordance with at least one example embodiment of the present disclosure;

FIGS. 5A and 5B illustrate, for at least one embodiment, an example flow diagram in accordance with at least one example embodiment of the present disclosure;

FIG. 6 is a simplified block diagram associated with an example ARM ecosystem system on chip (SOC) of the present disclosure; and

FIG. 7 is a simplified block diagram illustrating example logic that may be used to execute activities associated with the present disclosure.

The FIGURES of the drawings are not necessarily drawn to scale or proportion, as their dimensions, arrangements, and specifications can be varied considerably without departing from the scope of the present disclosure.

### DETAILED DESCRIPTION

The following detailed description sets forth example embodiments of apparatuses, methods, and systems relating to dual touch surface multiple function input devices. Features, such as structure(s), function(s), and/or characteristic(s) for example, are described with reference to one embodiment as a matter of convenience; various embodiments may be implemented with any suitable one or more described features.

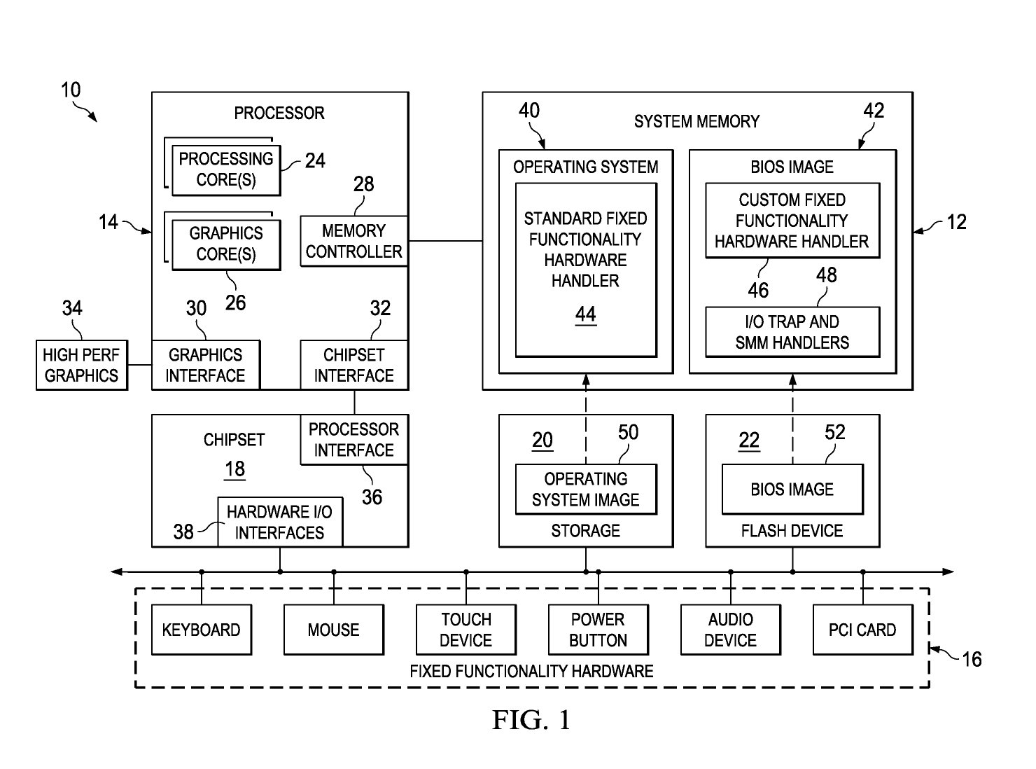

FIG. 1 is a simplified schematic diagram illustrating an embodiment of an electronic device 10, in accordance with at least one example embodiment. Electronic device 10 can include system memory 12, a processor 14, fixed functionality hardware 16 (e.g., a keyboard, a mouse, a touch device, a power button, an audio device, a peripheral component interconnect (PCI) card, etc.), a chipset 18, storage 20 (e.g., hard disk drive (HDD), solid state drive (SSD), etc.), a flash device 22, and high performance graphics 34. System memory 12 can include an operating system (OS) 40 and a Basic Input and Output System (BIOS) image 42. Operating system 40 can include a standard fixed functionality hardware handler 44. BIOS image 42 can include a custom fixed functionality hardware handler 46, and input/output (I/O) trap and system management mode (SMM) handlers 48. Processor 14 can include one or more processing cores 24, one or more graphics cores 26, a memory controller 28, a graphics interface 30 to communicate with high performance graphics 34, and a chipset interface 32 to communicate with chipset 18. Chipset 18 can include a processor interface 36 to communicate with processor 14 and one or more hardware I/O interfaces 38 to communicate with fixed functionality hardware 16 (and other hardware that is connected to electronic device 10). Storage 20 can include an operating system image 50. Flash device 22 can include a BIOS image 52. Flash device 22 may be any non-volatile computer storage device that can be electrically erased and reprogrammed. The examples of FIG. 1 are merely examples of an electronic configuration, and do not limit the scope of the claims. For example, the number of electrical components may vary, the placement of the electrical components may vary, and/or the like. Processor 14 can execute any type of instructions associated with the data to achieve the operations detailed herein in this Specification. In one example, processor 14 could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that can include digital logic, software, code, electronic instructions, or any suitable combination thereof.

With a traditional OS, the OS was knowledgeable about fixed functionality hardware used by the OS and certain assumptions were made about the hardware functioning in certain ways. For example, the power button (in fixed functionality hardware 16) could be used to turn on the system, turn off the system, or even put the system to sleep. When a system is off, in a sleep mode, hibernation state, etc. the OS is typically not functioning or has a reduced functionality. In such states, because the OS may not respond to a signal from fixed functionality hardware, a pre-OS can be used to route the signal to the OS. The pre-OS functions where there is no memory manager, no object manager, or no kernel and operates in real mode code and the BIOS. One drawback to using a pre-OS is that all events are routed to the OS and for certain events (e.g., power button toggling) it may be desirable to be able to intercept these hardware events and re-route them away from the generic OS handler to a custom handler.

In an embodiment, electronic device 10 can be configured to intercept memory mapped input/output (I/O) traffic for hardware events and then re-route the traffic to custom platform software at either a BIOS or OS-layer without needing to change the hardware routing on the platform. For example, memory mapped I/O traffic in advanced configuration and power interface (ACPI) operating systems targeted for the OS can be re-routed and handled using a system management interrupt (SMI). Note that the present disclosure can be applicable to ACPI™ Revision 5.0, released in November 2011. Additionally, the present disclosure is applicable to any other version of the ACPI™ Specification. The data associated with the SMI can be communicated to a custom handler where the interrupt action is performed. Once the SMI has been performed, BIOS (e.g., BIOS image 42) may use system memory 12 to communicate any special functions OS 40 should execute. This allows the system to repurpose fixed functionality hardware without having to change the hardware or the OS.

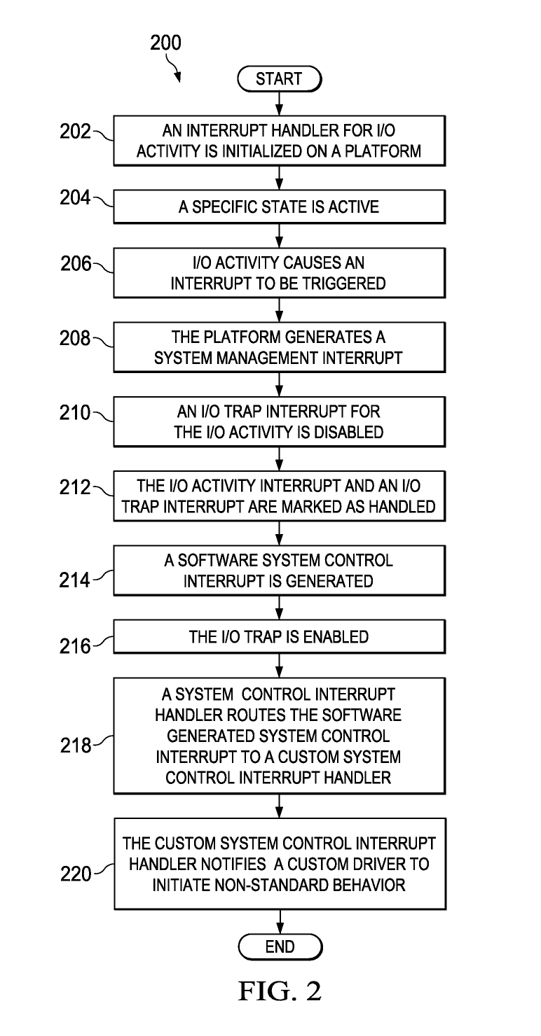

FIG. 2 is a simplified flowchart 200 illustrating example activities of a fixed functionality hardware device system in accordance with at least one example embodiment of the present disclosure. At 202, an interrupt handler for I/O activity is initialized on a platform (e.g., electronic device 10). As used herein, the term “platform” includes a hardware architecture and a software framework (including application frameworks), where the combination allows software (particularly application software) to run. The platform may include a computer architecture, an operating system, programming languages, related user interfaces, etc. At 204, a specific state (on the platform) is active. The specific state can be almost any state the system or platform may be in, for example, on battery power, at full power, in standby, in hibernation, on low battery power, running a specific OS, having a specific device connected, not have a specific device connected, running at a certain time, etc. At 206, I/O activity causes an interrupt to be triggered. At 208, the platform generates a system manage interrupt. At 210, an I/O trap interrupt for the I/O activity is disabled. At 212, the I/O activity interrupt and an I/O trap interrupt are marked as handled. At 214, a software system control interrupt is generated. At 216, the I/O trap is enabled. At 218, a system control interrupt handler routes the software generated system control interrupt to a custom system control interrupt handler. At 220, the custom system control interrupt handler notifies a custom driver to initiate custom behavior. The non-standard (i.e., custom) behavior is behavior that is not standard or part of the fixed functionality hardware. For example, if the system was in a hibernation state and the power button was pressed, standard behavior might be to shut off the system, whereas non-standard behavior might be to wake the system up.

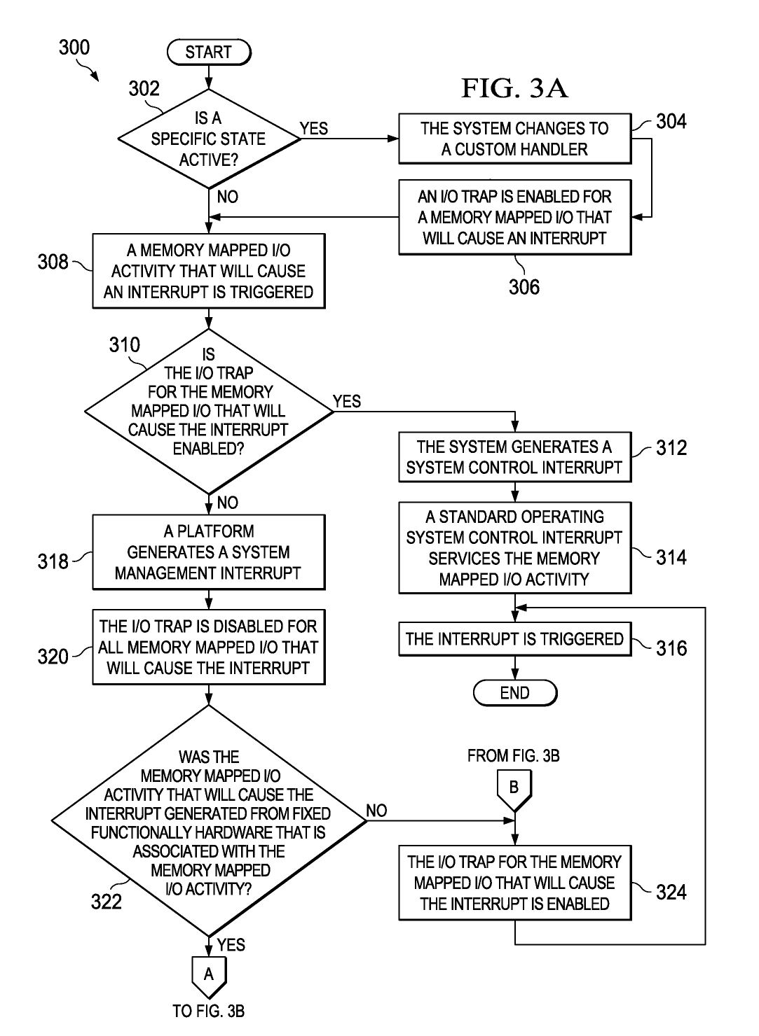

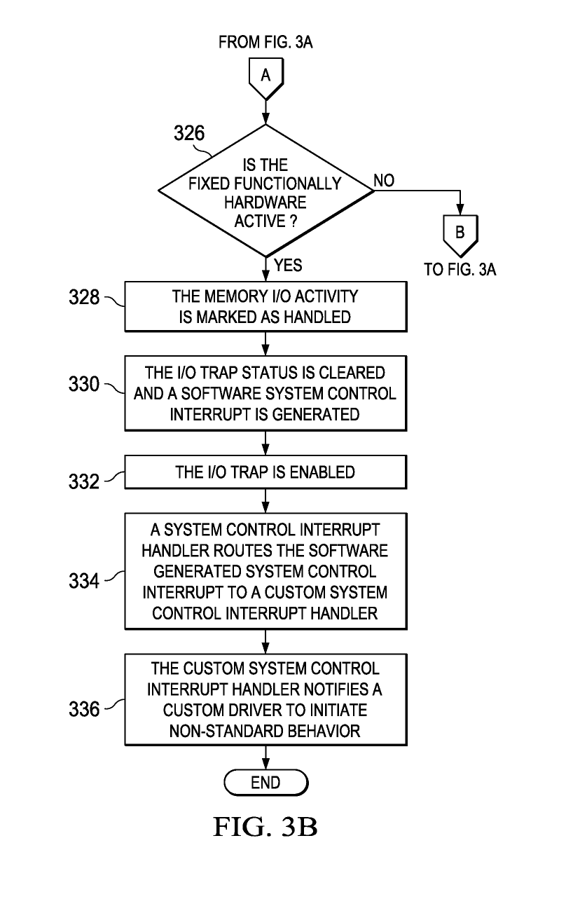

FIGS. 3A and 3B are simplified flowcharts 300 illustrating example activities of a fixed functionality hardware device system. At 302, the system determines if a specific state is active. The specific state can be almost any state the system or platform may be in, for example, on battery power, at full power, in standby, in hibernation, on low battery power, running a specific OS, having a specific device connected, not have a specific device connected, running at a certain time, etc. If the specific state is not active, the process moves to 308 where a memory mapped I/O activity that will cause an interrupt is triggered. If the specific state is active, then the system changes to a custom handler, as in 304. At 306, I/O trap is enabled for a memory mapped I/O that will cause an interrupt. At 308, the memory mapped I/O activity that will cause an interrupt is triggered.

At 310, the system determines if the I/O trap for the memory mapped I/O that will cause the interrupt is enabled. If the I/O trap for the memory mapped I/O that will cause the interrupt is enabled, then the system generates a system control interrupt, as in 312. At 314, a standard operating system control interrupt services the memory mapped I/O activity. At 316, the interrupt is triggered.

Referring back to 310, if the I/O trap for the memory mapped I/O that will cause the interrupt is not enabled, then a platform (associated with the system) generates a system management interrupt, as in 318. At 320, the I/O trap is disabled for all memory mapped I/O that will cause the interrupt. The I/O trap is disabled because the device that initiated the interrupt needs to be checked to determine its status and every time the device is checked, an interrupt is generated. At 322, the system determines if the memory mapped I/O activity that will cause the interrupt was generated from fixed functionality hardware that is associated with the memory mapped I/O activity. If the memory mapped I/O activity that will cause the interrupt was not generated from fixed functionality hardware that is associated with the memory mapped I/O activity, then the I/O trap for the memory mapped I/O that will cause the interrupt is enabled, as in 324. At 316, the interrupt is triggered.

If the memory mapped I/O activity that will cause the interrupt was generated from fixed functionality hardware that is associated with the memory mapped I/O activity, then the system determines if the fixed functionality hardware is active, as in 326 (FIG. 3B). If the fixed functionality hardware is not active, then the I/O trap for the memory mapped I/O that will cause the interrupt is enabled, as in 324 (FIG. 3A). If the fixed functionality hardware is active, then the memory I/O activity is marked as handled, as in 328. At 330 the I/O trap status is cleared and a software system control interrupt is generated. At 332, the I/O trap is enabled. At 334, a system control interrupt handler routes the software generated control system interrupt to a custom system control interrupt handler. At 336, the custom system control interrupt handler notifies a custom driver to initiate non-standard behavior.

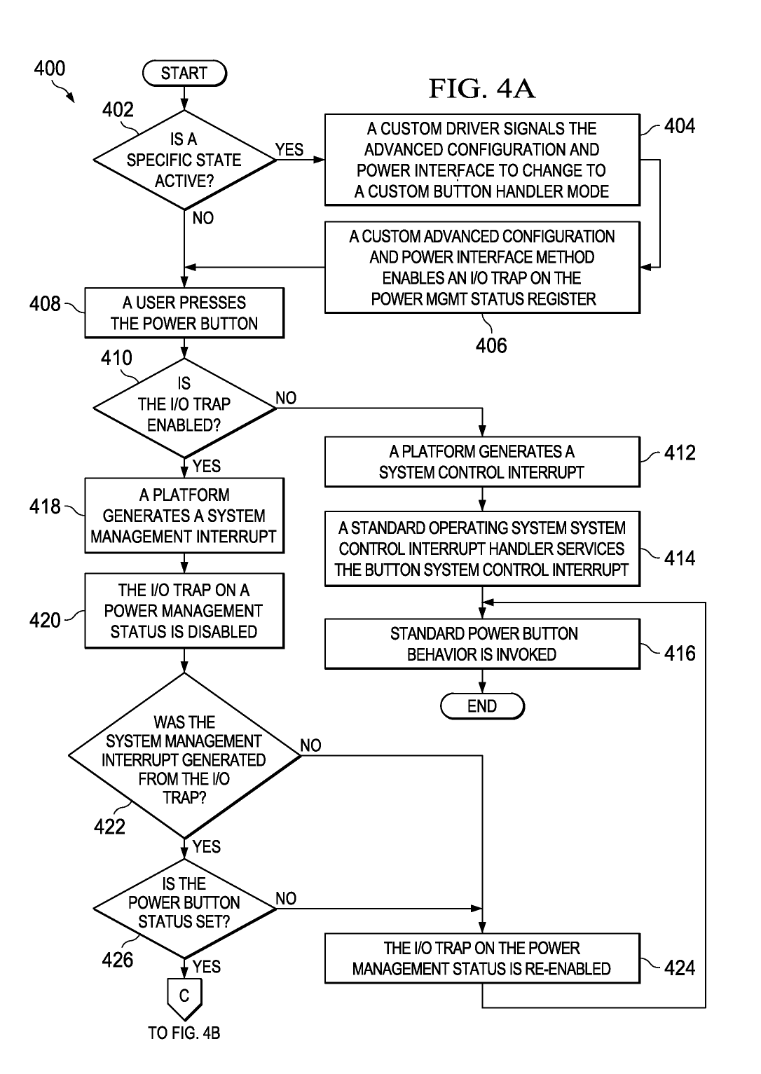

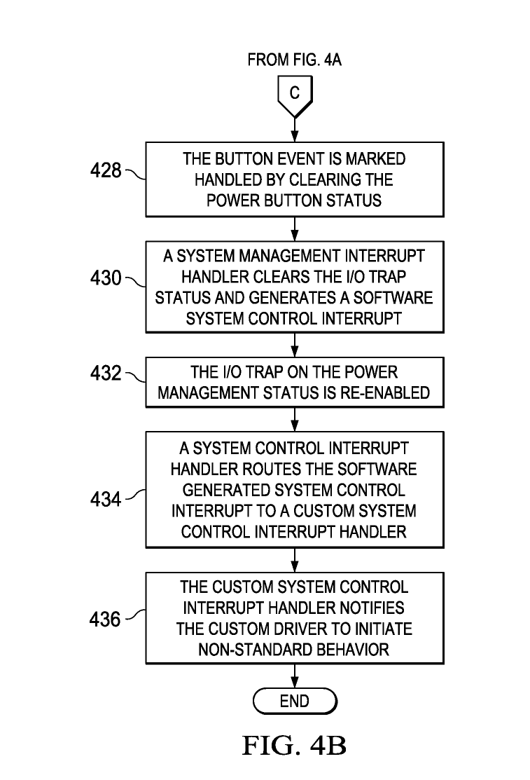

FIGS. 4A and 4B are simplified flowcharts 400 illustrating specific example activities of a fixed functionality hardware (e.g., a power button) device system. At 402, the system determines if a specific state is active. The specific state can be almost any state the system or platform may be in, for example, on battery power, at full power, in standby, in hibernation, on low battery power, running a specific OS, having a specific device connected, not have a specific device connected, running at a certain time, etc. If the specific state is not active, then the system waits for an action by a user, such as a user pressing the power button, as in 408. If the specific state is active, then a custom driver signals the ACPI to change to a custom button handler mode, as in 404. At 406, a custom ACPI method enables an I/O trap on the power management status register. At 408, a user presses the power button.

At 410, the system determines if the I/O trap is enabled. If the I/O trap is not enabled, then a platform (associated with the system) generates a system control interrupt, as in 412. At 414, a standard operating system control interrupt handler services the button system control interrupt. At 416, standard power button behavior is invoked.

If the I/O trap is enabled, then a platform generates a system management interrupt, as in 418. At 420, the I/O trap on a power management status is disabled. At 422, the system determines if the system management interrupt was generated from the I/O registry trap (e.g., PM1_STS registry). If the system determines that the system management interrupt was not generated from the I/O registry trap, then the I/O trap on power management status is re-enabled, as in 424. At 416, standard button behavior is invoked.

If the system determines that the system management interrupt was generated from the I/O registry trap, then the system determines if the power button status is set, as in 426. If the power button status is not set, then the I/O trap on power management status is re-enabled, as in 424. If the power button status is set, then the button event is marked as handled by clearing the power button status, as in 428 (FIG. 4B). At 430, a system management interrupt handler clears the I/O trap status and generates a software system control interrupt. At 432, the I/O trap on the power management status is re-enabled. At 434, a system control interrupt handler routes to software generated system control interrupt to a custom system control interrupt handler. At 436, the system control interrupt handler notifies a custom driver to initiate nonstandard behavior. For example, if the system was in a hibernation state and the power button was pressed, standard behavior might be to shut off the system, whereas non-standard behavior might be to wake the system up.

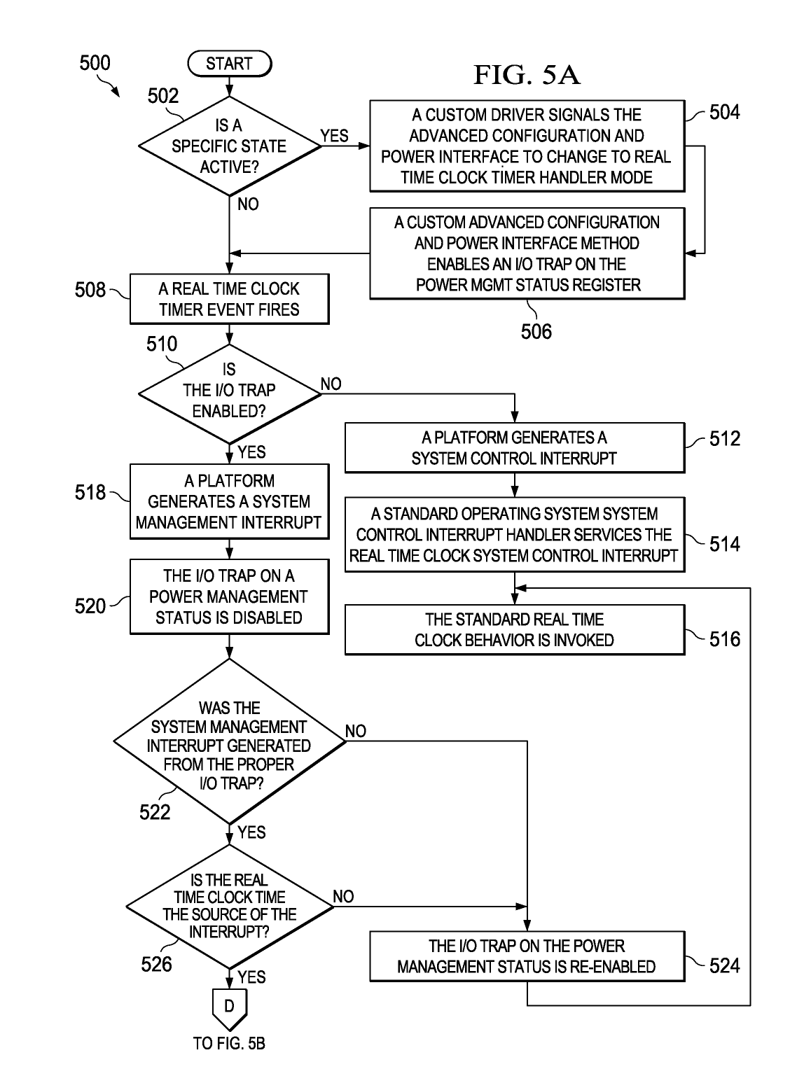

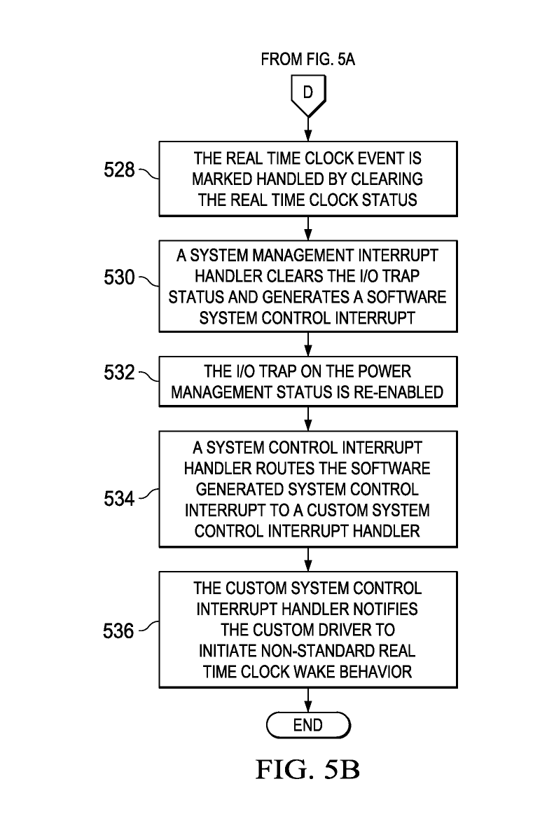

FIGS. 5A and 5B are simplified flowcharts 500 illustrating specific example activities of a fixed functionality hardware (e.g., a real time clock (RTC) timer handler) device system. At 502, the system determines if a specific state is active. The specific state can be almost any state the system or platform may be in, for example, on battery power, at full power, in standby, in hibernation, on low battery power, running a specific OS, having a specific device connected, not have a specific device connected, running at a certain time, etc. If the specific state is not active, then the system waits for an action, such as a RTC timer event fires, as in 508. If the specific state is active, then a custom driver signals to the ACPI to change to RTC timer handler mode, as in 504. At 506, a custom ACPI method enables an I/O trap on the power management status register. At 508, a RTC timer event fires.

At 510, the system determines if the I/O trap is enabled. If the I/O trap is not enabled, then a platform generates a system control interrupt, as in 512. At 514, a standard operating system control interrupt handler services the RTC system control interrupt. At 516, the standard RTC behavior is invoked.

If the I/O trap is enabled, then a platform generates a system management interrupt, as in 518. At 520, the I/O trap on a power management status is disabled. At 522, the system determines if the system management interrupt was generated from the proper I/O registry trap. If the system determines that the system management interrupt was not generated from the proper I/O registry trap, then the I/O trap on the power management status is re-enabled, as in 524. At 516, the standard RTC behavior is invoked.

If the system determines that the system management interrupt was generated from the proper I/O registry trap, then the system determines if the RTC timer is the source of the interrupt, as in 526. If the RTC timer is not the source of the interrupt, then the I/O trap on the power management status is re-enabled, as in 524. If the RTC timer is the source of the interrupt, then the RTC event is marked as handled by clearing the RTC status, as in 528 (FIG. 5B). At 530, a system management interrupt handler clears the I/O trap status and generates a software system control interrupt. At 532, the I/O trap on the power management status is re-enabled. At 534, a system control interrupt handler routes to software generated system control interrupt to a custom system control interrupt handler. At 536, the system control interrupt handler notifies a custom driver to initiate nonstandard RTC wake behavior.

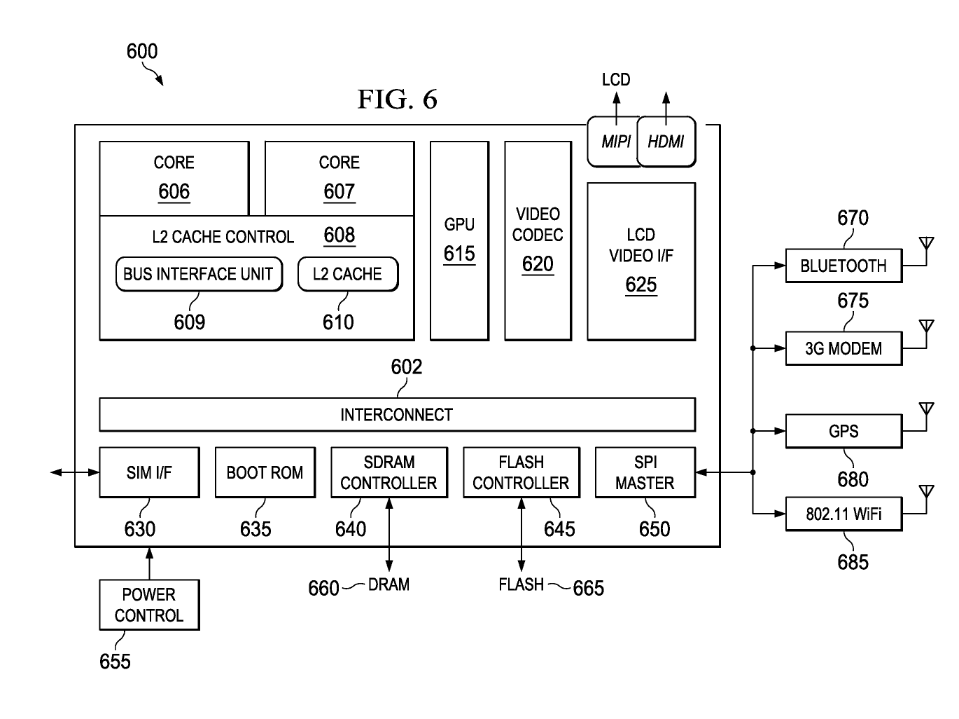

FIG. 6 is a simplified block diagram associated with an example ARM ecosystem SOC 600 of the present disclosure. At least one example implementation of the present disclosure can include an integration of the power savings features discussed herein and an ARM component. For example, the example of FIG. 6 can be associated with any ARM core (e.g., A-9, A-15, etc.). Further, the architecture can be part of any type of tablet, smartphone (inclusive of Android™ phones, i-Phones™), i-Pad™, Google Nexus™, Microsoft Surface™, personal computer, server, video processing components, laptop computer (inclusive of any type of notebook), Ultrabook™ system, any type of touch-enabled input device, etc.

In this example of FIG. 6, ARM ecosystem SOC 600 may include multiple cores 606-607, an L2 cache control 608, a bus interface unit 609, an L2 cache 610, a graphics processing unit (GPU) 615, an interconnect 602, a video codec 620, and a liquid crystal display (LCD) I/F 625, which may be associated with mobile industry processor interface (MIPI)/high-definition multimedia interface (HDMI) links that couple to an LDC.

ARM ecosystem SOC 600 may also include a subscriber identity module (SIM) I/F 630, a boot read-only memory (ROM) 635, a synchronous dynamic random access memory (SDRAM) controller 640, a flash controller 645, a serial peripheral interface (SPI) master 650, a suitable power control 655, a dynamic RAM (DRAM) 660, and flash 665. In addition, one or more example embodiment include one or more communication capabilities, interfaces, and features such as instances of Bluetooth™ 670, a 3G modem 675, a global positioning system (GPS) 680, and an 802.11 WiFi 685.

In operation, the example of FIG. 6 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

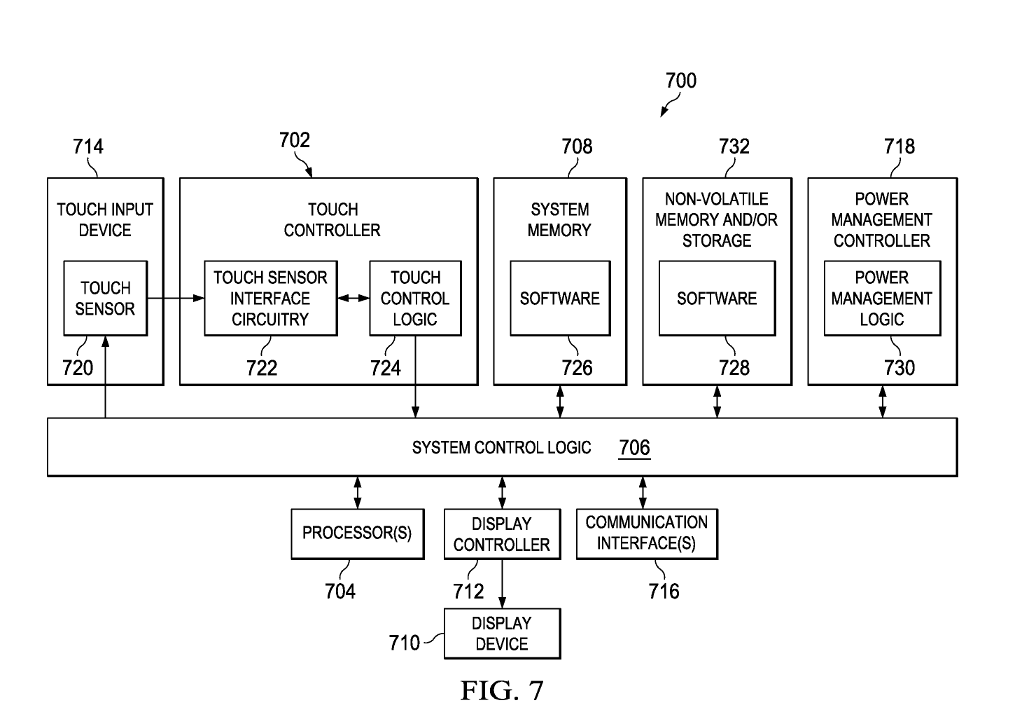

FIG. 7 is a simplified block diagram illustrating potential electronics and logic that may be associated with any of the power saving operations discussed herein. In at least one example embodiment, system 700 can include a touch controller 702, one or more processors 704, system control logic 706 coupled to at least one of processor(s) 704, system memory 708 coupled to system control logic 706, non-volatile memory and/or storage device(s) 732 coupled to system control logic 706, display controller 712 coupled to system control logic 732, display controller 712 coupled to a display device 710, power management controller 718 coupled to system control logic 706, and/or communication interfaces 716 coupled to system control logic 706.

System control logic 706, in at least one embodiment, can include any suitable interface controllers to provide for any suitable interface to at least one processor 704 and/or to any suitable device or component in communication with system control logic 706. System control logic 706, in at least one example embodiment, can include one or more memory controllers to provide an interface to system memory 708. System memory 708 may be used to load and store data and/or instructions, for example, for system 700. System memory 708, in at least one example embodiment, can include any suitable volatile memory, such as suitable dynamic random access memory (DRAM) for example. System control logic 706, in at least one example embodiment, can include one or more I/O controllers to provide an interface to display device 710, touch controller 702, and non-volatile memory and/or storage device(s) 732.

Non-volatile memory and/or storage device(s) 732 may be used to store data and/or instructions, for example within software 728. Non-volatile memory and/or storage device(s) 732 may include any suitable non-volatile memory, such as flash memory for example, and/or may include any suitable non-volatile storage device(s), such as one or more hard disc drives (HDDs), one or more compact disc (CD) drives, and/or one or more digital versatile disc (DVD) drives for example.

Power management controller 718 may include power management logic 730 configured to control various power management and/or power saving functions disclosed herein or any part thereof. In at least one example embodiment, power management controller 718 is configured to reduce the power consumption of components or devices of system 700 that may either be operated at reduced power or turned off when the electronic device is in a closed configuration. For example, in at least one example embodiment, when the electronic device is in a closed configuration, power management controller 718 performs one or more of the following: power down the unused portion of the display and/or any backlight associated therewith; allow one or more of processor(s) 704 to go to a lower power state if less computing power is required in the closed configuration; and shutdown any devices and/or components that are unused when an electronic device is in the closed configuration.

Communications interface(s) 716 may provide an interface for system 700 to communicate over one or more networks and/or with any other suitable device. Communications interface(s) 716 may include any suitable hardware and/or firmware. Communications interface(s) 716, in at least one example embodiment, may include, for example, a network adapter, a wireless network adapter, a telephone modem, and/or a wireless modem.

System control logic 706, in at least one example embodiment, can include one or more I/O controllers to provide an interface to any suitable input/output device(s) such as, for example, an audio device to help convert sound into corresponding digital signals and/or to help convert digital signals into corresponding sound, a camera, a camcorder, a printer, and/or a scanner.

For at least one example embodiment, at least one processor 704 may be packaged together with logic for one or more controllers of system control logic 706. In at least one example embodiment, at least one processor 704 may be packaged together with logic for one or more controllers of system control logic 706 to form a System in Package (SiP). In at least one example embodiment, at least one processor 704 may be integrated on the same die with logic for one or more controllers of system control logic 706. For at least one example embodiment, at least one processor 704 may be integrated on the same die with logic for one or more controllers of system control logic 706 to form a System on Chip (SoC).

For touch control, touch controller 702 may include touch sensor interface circuitry 722 and touch control logic 724. Touch sensor interface circuitry 722 may be coupled to detect touch input over a first touch surface layer and a second touch surface layer of a display (i.e., display device 710). Touch sensor interface circuitry 722 may include any suitable circuitry that may depend, for example, at least in part on the touch-sensitive technology used for a touch input device. Touch sensor interface circuitry 722, in one embodiment, may support any suitable multi-touch technology. Touch sensor interface circuitry 722, in at least one embodiment, can include any suitable circuitry to convert analog signals corresponding to a first touch surface layer and a second surface layer into any suitable digital touch input data. Suitable digital touch input data for at least one embodiment may include, for example, touch location or coordinate data.

Touch control logic 724 may be coupled to help control touch sensor interface circuitry 722 in any suitable manner to detect touch input over a first touch surface layer and a second touch surface layer. Touch control logic 724 for at least one example embodiment may also be coupled to output in any suitable manner digital touch input data corresponding to touch input detected by touch sensor interface circuitry 722. Touch control logic 724 may be implemented using any suitable logic, including any suitable hardware, firmware, and/or software logic (e.g., non-transitory tangible media), that may depend, for example, at least in part on the circuitry used for touch sensor interface circuitry 722. Touch control logic 724 for at least one embodiment may support any suitable multi-touch technology.

Touch control logic 724 may be coupled to output digital touch input data to system control logic 706 and/or at least one processor 704 for processing. At least one processor 704 for at least one embodiment may execute any suitable software to process digital touch input data output from touch control logic 724. Suitable software may include, for example, any suitable driver software and/or any suitable application software. As illustrated in FIG. 7, system memory 708 may store suitable software 726 and/or non-volatile memory and/or storage device(s).

Note that in some example implementations, the functions outlined herein may be implemented in conjunction with logic that is encoded in one or more tangible, non-transitory media (e.g., embedded logic provided in an application-specific integrated circuit (ASIC), in digital signal processor (DSP) instructions, software [potentially inclusive of object code and source code] to be executed by a processor, or other similar machine, etc.). In some of these instances, memory elements can store data used for the operations described herein. This can include the memory elements being able to store software, logic, code, or processor instructions that are executed to carry out the activities described herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), a DSP, an erasable programmable read only memory (EPROM), electrically erasable programmable read-only memory (EEPROM)) or an ASIC that can include digital logic, software, code, electronic instructions, or any suitable combination thereof.

Note that with the examples provided above, as well as numerous other examples provided herein, interaction may be described in terms of layers, protocols, interfaces, spaces, and environments more generally. However, this has been done for purposes of clarity and example only. In certain cases, it may be easier to describe one or more of the functionalities of a given set of flows by only referencing a limited number of components. It should be appreciated that the architectures discussed herein (and its teachings) are readily scalable and can accommodate a large number of components, as well as more complicated/sophisticated arrangements and configurations. Accordingly, the examples provided should not limit the scope or inhibit the broad teachings of the present disclosure, as potentially applied to a myriad of other architectures.

It is also important to note that the blocks in the flow diagrams illustrate only some of the possible signaling scenarios and patterns that may be executed by, or within, the circuits discussed herein. Some of these blocks may be deleted or removed where appropriate, or these steps may be modified or changed considerably without departing from the scope of teachings provided herein. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by the present disclosure in that any suitable arrangements, chronologies, configurations, and timing mechanisms may be provided without departing from the teachings provided herein.

It is also imperative to note that all of the Specifications, protocols, and relationships outlined herein (e.g., specific commands, timing intervals, supporting ancillary components, etc.) have only been offered for purposes of example and teaching only. Each of these data may be varied considerably without departing from the spirit of the present disclosure, or the scope of the appended claims. The specifications apply to many varying and non-limiting examples and, accordingly, they should be construed as such. In the foregoing description, example embodiments have been described. Various modifications and changes may be made to such embodiments without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

### Example Embodiment Implementations

One particular example implementation of an electronic device may include means for One particular example implementation may include an apparatus that can include a means for causing (e.g., using a controller, a processor, circuitry, software, hardware, etc.) an interrupt to be triggered based on input/output (I/O) activity when a predetermined state is activated on a platform; generating (e.g., using a controller, a processor, circuitry, software, hardware, etc.) a system management interrupt based on the interrupt; generating (e.g., using a controller, a processor, circuitry, software, hardware, etc.) a system control interrupt based on the interrupt source; and routing (e.g., using an interface, links, busses, a controller, a processor, circuitry, software, hardware, etc.) the system control interrupt to a custom system control interrupt handler.

What is claimed is:

1. An apparatus, comprising:
logic at least a portion of which is in hardware, the logic to:
trigger a particular interrupt based, at least in part, on input/output (I/O) activity when a predetermined state is activated on a platform;
generate a system control interrupt based, at least in part, on a source associated with the particular interrupt; and
route the system control interrupt to a custom system control interrupt handler.

2. The apparatus of claim 1, the apparatus further comprising logic to:
generate a system management interrupt; and
mark a memory mapped I/O activity interrupt and an I/O trap interrupt as handled when the system management interrupt is generated.

3. The apparatus of claim 1, the apparatus further comprising logic to:
generate a software system control interrupt when the particular interrupt is triggered from I/O activity of fixed functionality hardware; and
route the generated software system control interrupt to the custom system control interrupt handler using a system management interrupt handler.

4. The apparatus of claim 3, wherein the custom system control interrupt handler is to notify a custom driver to initiate custom behavior.

5. The apparatus of claim 1, the apparatus further comprising logic to:
initialize an interrupt handler for I/O activity on the platform.

6. The apparatus of claim 1, wherein the system control interrupt is prohibited from being routed to the custom system control interrupt handler if the predetermined state is not activated on the platform.

7. The apparatus of claim 1, wherein a standard operating system control interrupt is to service memory mapped I/O activity if the predetermined state is not activated on the platform.

8. The apparatus of claim 1, the apparatus further comprising logic to:
disable an I/O trap interrupt for the I/O activity.

9. The apparatus of claim 1, the apparatus further comprising logic to:
enable the I/O trap interrupt after routing the system control interrupt to the custom system control interrupt handler.

10. A system, comprising:
a processor; and
a memory to store instructions that when executed by the processor performs operations, comprising:
triggering a particular interrupt based, at least in part, on input/output (I/O) activity when a predetermined state is activated on a platform;
generating a system control interrupt based, at least in part, on a source associated with the particular interrupt; and
routing the system control interrupt to a custom system control interrupt handler.

11. The system of claim 10, the operations further comprising:
generating a system management interrupt;
marking a memory mapped I/O activity interrupt and an I/O trap interrupt as handled when the system management interrupt is generated.

12. The system of claim 10, the operations further comprising:
generating a software system control interrupt when the particular interrupt is triggered from I/O activity of fixed functionality hardware; and
routing the generated software system control interrupt to the custom system control interrupt handler using a system management interrupt handler.

13. The system of claim 10, wherein the custom system control interrupt handler is to notify a custom driver to initiate custom behavior.

14. The system of claim 10, the operations further comprising:
initializing an interrupt handler for I/O activity on the platform.

15. The system of claim 10, wherein the system control interrupt is prohibited from being routed to the custom system control interrupt handler if the predetermined state is not activated on the platform.

16. The system of claim 10, wherein a standard operating system control interrupt is to service memory mapped I/O activity if the predetermined state is not activated on the platform.

17. The system of claim 10, the operations further comprising:
disabling an I/O trap interrupt for the I/O activity; and
enabling the I/O trap interrupt after routing the system control interrupt to the custom system control interrupt handler.

18. A non-transitory computer readable medium comprising instructions that, when executed by a processor, cause an apparatus to:
trigger a particular interrupt based, at least in part, on input/output (I/O) activity when a predetermined state is activated on a platform;
generate a system control interrupt based, at least in part, on a source associated with the particular interrupt; and
route the system control interrupt to a custom system control interrupt handler.

19. The medium of claim 18, wherein the instructions further cause the apparatus to:
generate a system management interrupt;
mark a memory mapped I/O activity interrupt and an I/O trap interrupt as handled when the system management interrupt is generated.

20. The medium of claim 18, wherein the instructions further cause the apparatus to:
generate a software system control interrupt when the particular interrupt is triggered from I/O activity of fixed functionality hardware; and
route the generated software system control interrupt to the custom system control interrupt handler using a system management interrupt handler.

21. The medium of claim 18, wherein the custom system control interrupt handler is to notify a custom driver to initiate custom behavior.

22. The medium of claim 18, wherein the instructions further cause the apparatus to:
initialize an interrupt handler for I/O activity on the platform.

23. The medium of claim 18, wherein the instructions further cause the apparatus to:
disable an I/O trap interrupt for the I/O activity.

24. A system, comprising:
means for triggering a particular interrupt based, at least in part, on input/output (I/O) activity when a predetermined state is activated on a platform;
means for generating a system control interrupt based, at least in part, on a source associated with the particular interrupt; and
means for routing the system control interrupt to a custom system control interrupt handler.

25. The system of claim 24, further comprising:
means for generating a system management interrupt;
means for marking a memory mapped I/O activity interrupt and an I/O trap interrupt as handled when the system management interrupt is generated.

26. The system of claim 24, further comprising:
means for generating a software system control interrupt when the particular interrupt is triggered from I/O activity of fixed functionality hardware; and
means for routing the generated software system control interrupt to the custom system control interrupt handler using a system management interrupt handler.

27. The system of claim 24, wherein the custom system control interrupt handler is to notify a custom driver to initiate custom behavior.

28. The system of claim 24, further comprising:
means for initializing an interrupt handler for I/O activity on the platform.

29. The system of claim 24, wherein the system control interrupt is prohibited from being routed to the custom system control interrupt handler if the predetermined state is not activated on the platform.

30. The system of claim 24, wherein a standard operating system control interrupt is to service memory mapped I/O activity if the predetermined state is not activated on the platform.
